(19) United States
(12) Patent Application Publication
(10) Pub. No.: US 2006/0076080 A1
(43) Pub. Date: Apr. 13, 2006

(54) TINTING METHOD AND APPARATUS

(75) Inventor: Martin M. Salas, Charlotte, NC (US)

Correspondence Address: ADAMS EVANS P.A., 2180 TWO WACHOVIA CENTER, CHARLOTTE, NC, 28282, US

(73) Assignee: ULTRABLEND LLC, Charlotte, NC (US)

(21) Appl. No.: 11/163,302

(22) Filed: Oct. 13, 2005

Related U.S. Application Data
(60) Provisional application No. 60/618,253, filed on Oct. 13, 2004.

(51) Int. Cl. B65B 1/04; B65B 3/04; B67C 3/02

(52) U.S. Cl. 141/104

(57) ABSTRACT

A fluid tinting method includes: determining a preselected quantity of a colorant to be dispensed into a container to achieve a desired final color; determining a time required to dispense the preselected quantity of the colorant based on a flow characteristic of a dispensing apparatus; and operating the dispensing apparatus for the time determined. An apparatus for carrying out the tinting method includes one or more colorant sub-systems each including an apparatus for creating a flow of a colorant and a colorant valve which receives the colorant. The colorant valve is moveable between a first position which prevents colorant flow to a container, and a second position which allows colorant flow to the container. A control system is operable to move the colorant valve to the second position for a preselected period of time based on a preselected quantity of colorant to be dispensed.

### CROSS-REFERENCE TO RELATED APPLICATIONS

This application claims the benefit of Provisional Application Ser. No. 60/618,253, filed Oct. 13, 2004.

### BACKGROUND OF THE INVENTION

This invention relates generally to mixing fluids and more particularly to a method and apparatus for tinting paint.

Paints are provided in a wide variety of colors. Because it is highly impractical to offer pre-mixed paint in thousands of colors, paint suppliers and retail stores stock paint in several base colors and finishes and provide samples or chips of available colors. By selectively adding colorants of a dozen or more colors to the base paint, it is possible to provide the customer with the exact color he or she desires.

This tinting process is often carried out with an automatic colorant dispensing machine. Individually pumped reservoirs containing colorants (which consist of a pigment dispersed in a vehicle) of differing colors are typically connected to a set of valves which, under microprocessor control, direct appropriate amounts of colorants through dispensing tubes to a nozzle. A can of base paint is placed under the stationary nozzle. The machine, having been programmed to dispense the proper amount of each colorant, is activated and the colorant is then directed through the nozzle to the paint can. The paint can is capped and agitated, which thoroughly mixes the colorant throughout the base paint and produces paint of the desired color.

Prior art paint tinting machines are usually based on open-loop control of the dispensed colorant volume. While accurate, these systems require relatively expensive components, for example positive-displacement colorant pumps combined with rotary encoders.

### BRIEF SUMMARY OF THE INVENTION

Accordingly, it is an object of the invention to provide a paint tinting process and system which is simple and avoids expensive components.

It is another object of the invention to provide a paint tinting process and system which uses time-based metering.

It is another object of the invention to provide a paint tinting apparatus which does not require a pump.

The above-mentioned need is met by the present invention, which according to one embodiment provides a method of tinting a fluid, including: (a) providing means for dispensing a colorant into a container; (b) determining a preselected quantity of the colorant to be dispensed into the container to achieve a desired final color; (c); determining a time required to dispense the preselected quantity of the colorant based on a flow characteristic of the dispensing means; and (d) operating the dispensing means for the time so as to dispense the preselected quantity of colorant into the container.

According to another embodiment of the invention, steps (a) through (d) are repeated for a plurality of colorants which collectively produce the desired final color.

According to another embodiment of the invention, the flow characteristic is a steady-state flow rate.

According to another embodiment of the invention, the flow characteristic is an effective flow rate which takes into account an initial period of unsteady flow.

According to another embodiment of the invention, the step of determining a time required to dispense the preselected quantity of the colorant is carried out by referencing stored data representative of the quantity of colorant dispensed per unit time based on a known flow rate.

According to another embodiment of the invention, the method further includes recirculating the colorant in a flow loop at a steady state flow rate when the colorant is not being dispensed.

According to another embodiment of the invention, the method further includes providing a control system operably connected to the dispensing means, the control system programmed to operate the dispensing means for the time.

According to another embodiment of the invention, the control system is programmed to: receive a user input representing a quantity of a base fluid to be mixed; receive a user input representing a final color desired; and reference stored data which describes the correct quantity of each of a plurality of colorants required to produce the desired final color for a given quantity of base fluid in order to determine the preselected quantity of each of the colorants to be dispensed into the base fluid.

According to another embodiment of the invention, the container holds a base fluid therein prior to dispensing the colorant.

According to another embodiment of the invention, a tinting apparatus includes: at least one colorant sub-system for dispensing a colorant into a container, comprising: means for creating a flow of the colorant; a colorant valve which receives the colorant, the valve moveable between a first position which prevents flow of the colorant to a container, and a second position which allows flow of the colorant to the container; and a control system operable to move the colorant valve to the second position for a preselected period of time based on a preselected quantity of colorant to be dispensed.

According to another embodiment of the invention, the tinting apparatus further includes additional colorant sub-systems for dispensing additional colorants into the base fluid, wherein each of the colorant sub-systems is operably connected to the controller.

According to another embodiment of the invention, the colorant sub-system includes: a reservoir for holding a supply of the colorant; a pump for creating a flow of the colorant from the reservoir to the colorant valve; and means for recirculating the flow of colorant from the colorant valve to the reservoir when the colorant valve is in the first position.

According to another embodiment of the invention, the control system includes: a programmable logic controller operably connected to the colorant valve; and a programmable computer operably connected to the programmable logic controller.

According to another embodiment of the invention, the control system includes a stored calibration which correlates the quantity of colorant dispensed to a unit time at a specific flowrate.

According to another embodiment of the invention, the control system includes stored data which describes the correct quantity of each colorant required to produce the desired color for a given volume of base fluid.

### BRIEF DESCRIPTION OF THE DRAWINGS

The subject matter that is regarded as the invention may be best understood by reference to the following description taken in conjunction with the accompanying drawing figures in which:

FIG. 1 is a perspective view of a paint tinting machine constructed in accordance with the present invention;

FIG. 2 is schematic diagram of the internal components of the paint tinting machine of FIG. 1;

FIG. 3A is a flowchart illustrating a paint tinting process according to the present invention;

FIG. 3B is a continuation of the flowchart shown in FIG. 3A; and

FIG. 4 is a schematic representation of a calibration chart for use with the present invention.

### DETAILED DESCRIPTION OF THE INVENTION

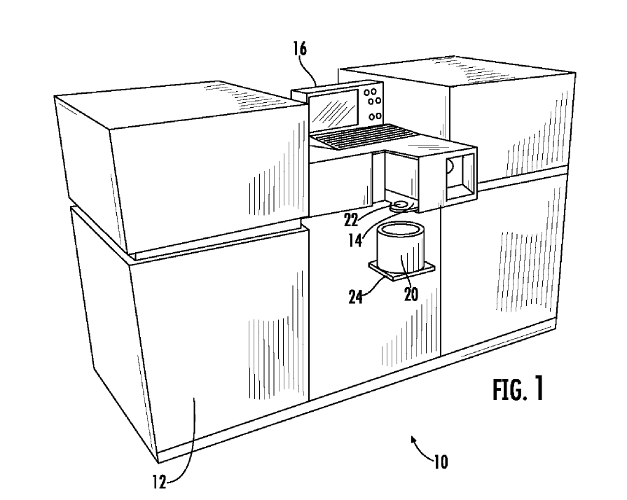

Referring to the drawings wherein identical reference numerals denote the same elements throughout the various views, FIG. 1 shows an automatic paint tinting machine 10. It should be noted that the present invention is equally applicable to the precise mixing of any other type of fluid. A paint can 20 contains base paint ready for tinting with pigment, which is delivered by the operation of the tinting machine 10. The tinting machine 10 may also be used to deliver colorants to an empty container. A frame 12 houses the internal components of the tinting machine 10. A movable mounting plate 14 is connected to the frame 12. A microprocessor-based computer 16 controls several aspects of the delivery of pigment which will likewise be discussed in greater detail below.

A sight 22, which is preferably formed as a hole in mounting plate 14, is positioned above the paint can 20. The primary function of the sight 22 is to permit the operator of the machine 10 to have a reference point for placement of the paint can 20 so that pigment is reliably delivered thereto. Shelf 24 is preferably designed to be of sufficient size and strength to accommodate at least a standard one-gallon paint can and preferably as wide a range of paint containers as are reasonably likely to be used in conjunction with the machine 10, and in fact may be adjustable to accommodate containers as necessary. In the preferred embodiment, the operator places the paint can 20 on the shelf 24 and ensures that the mouth of the paint can 20 or, in some embodiments, a bunghole in the can lid, is aligned with the sight 22.

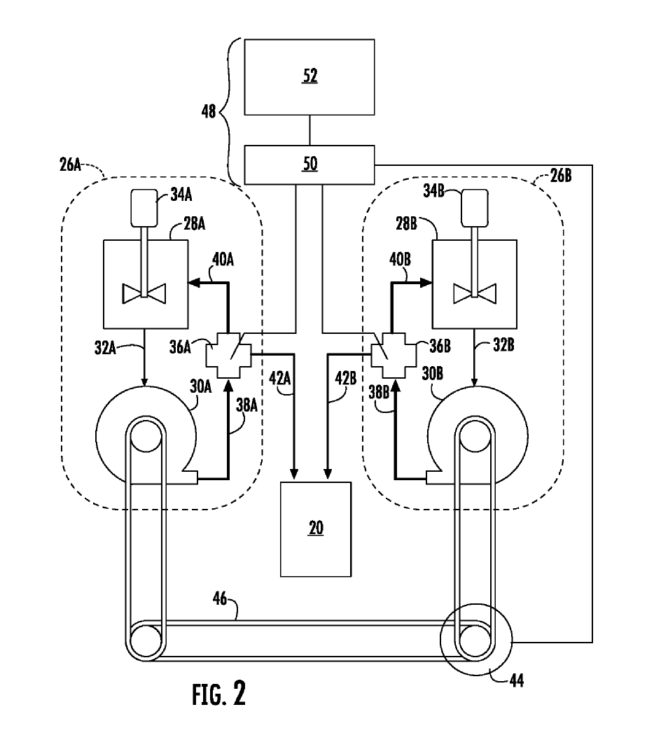

FIG. 2 is a schematic view of the internal components of the tinting machine 10. A plurality of individual colorant sub-systems are provided, one for each colorant in the paint manufacturer's color system. In the particular example shown, first and second colorant sub-systems 26A and 26B are shown for the purposes of illustration However, any number of colorant sub-systems desired may be used, and in practical application the tinting systems in common use by most paint manufacturers include several colorants, for example twelve. It should also be noted that the base paint has its own color characteristics. It therefore can be treated in the same manner as a “colorant” and the tinting machine 10 may be provided with a separate colorant sub-system 26 for dispensing the base paint.

Each of the colorant sub-systems 26A and 26B includes a colorant reservoir 28A, 28B which are connected to respective colorant pumps 30A, 30B by supply lines 32A, 32B. Motorized stirrers 34A and 34B may be provided to keep the colorants adequately mixed. The colorant pumps 30A, 30B are in turn connected to corresponding colorant valves 36A and 36B by pump discharge lines 38A, 38B. Each of the colorant valves 36A, 36B is a three-way type of valve which directs colorant received from the respective colorant pump 30A, 30B either back to the colorant reservoirs 28A, 28B through return lines 40A, 40B, or out through dispensing lines 42A, 42B and into a paint can 20, depending on how the colorant valves 36A, 36B are set. The colorant valves 36A, 36B are arranged to be operated remotely, for example by providing individual solenoids of a known type (not shown) connected to each of the colorant valves 36A, 36B.

Owing to the method of operation of the present system, which is explained in more detail below, no particular type of pump is required to move the colorants. Any pump which will create a steady flow of the colorants through the piping loop from the colorant reservoirs 28A, 28B through the respective colorant valve 36A or 36B may be used. Therefore, both positive-displacement and non-positive-displacement pumps are appropriate. Furthermore, the colorant pumps 30A, 30B could be eliminated entirely by providing means such as inert gas or compressed air to pressurize the colorant reservoirs 28A, 28B.

The colorant pumps 30A, 30B may be operated in various ways. Each colorant pump 30A, 30B may be driven by its own electric motor. However, preferably to minimize the number of components used, all of the colorant pumps 30A, 30B are driven by a single prime mover through a mechanical drive train using belts, gears, shafts, or a combination thereof. The illustrated example in FIG. 2 shows an electric motor 44 controlled by a variable-speed AC drive of a known type. The motor 44 in turn drives the colorant pumps 30A, 30B through a belt and pulley system 46. The AC drive may include means for outputting a motor speed signal.

The colorant valves 36A, 36B and the colorant pumps 30A, 30B are connected to a control system 48 which in the illustrated example includes a programmable logic controller (PLC) 50 of a known type and a computer 52 of a known type, such as a PC-compatible computer, operating in concert. The PLC 50 operates the electric motor 44 (through the AC drive) and colorant valves 36A, 36B based on commands received from the computer 52. The PLC 50 may be programmed to execute a series of steps based on relatively simple high-level commands from the computer 52.

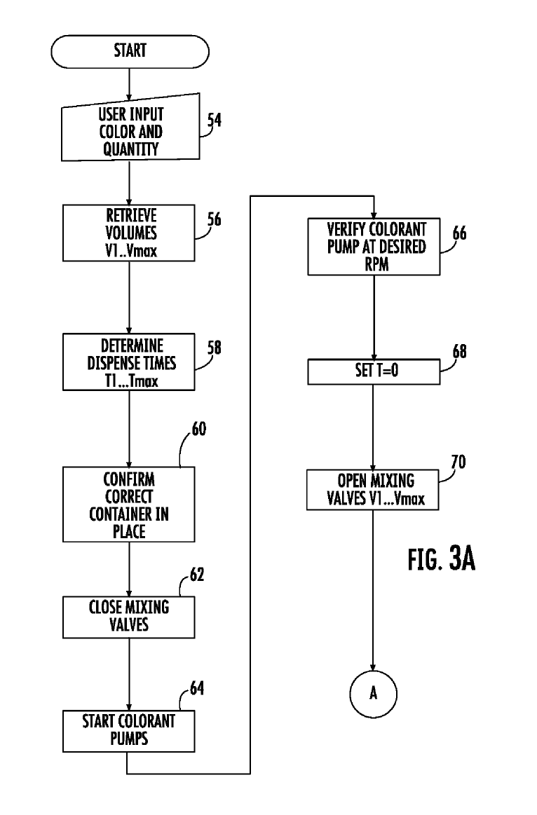

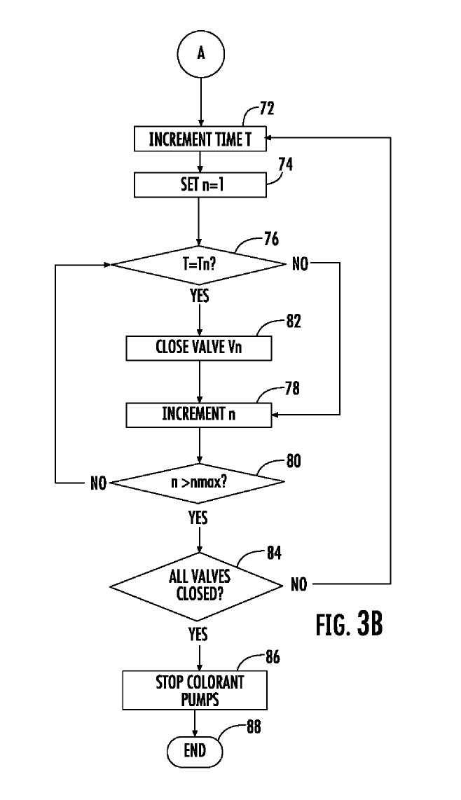

FIGS. 3A and 3B depict the steps involved in tinting a container of paint. The manner in which of these steps are executed may vary. For example, each step may be individually triggered by a control software program running on the computer 52. Alternatively, the control software of the computer 52 may simply provide an indication of the required colorant volumes to the PLC, in which case the PLC 50 would be programmed to execute the detailed steps of the tinting process.

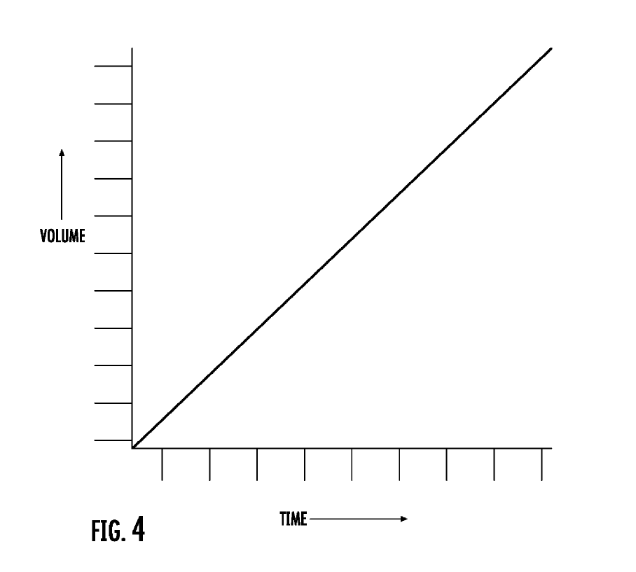

The process begins at block 54. The user inputs into the computer 52 the desired final color and quantity of paint to be tinted. At block 56, the control software refers to a stored “formula” which describes the correct quantity of each colorant required to produce the desired color for a given volume of tint base. Typically, colorants are mixed by volume, but mass may also be used as a measure. The control system 48 then determines in block 58 the proper duration of flow or “dispense times” Tn=T1 . . . Tmax for each colorant required by using a stored calibration which correlates the quantity of colorant for each unit time at a specific flowrate. This calibration may also allow for time delays in the operation of the electromechanical portions of the system. FIG. 4 shows a graphical example of a chart representing a stored calibration. An equivalent numerical look-up table or other data format may also be used for the same purpose, or a curve fit equation could be used to calculate the dispense time for each colorant. Not all of the colorants are required for every chosen color. For example, a particular color may require only four colorants out of twelve available colorants. The control system 48 then verifies that the correct size container is in place at block 60.

Once all the initial conditions are satisfied, the user provides a “dispense” command. The control system 48 then causes the dispensing valves 36A, 36B to move to, or to remain in, the recirculation (or “closed”) position at block 62 and the colorant pumps 30A, 30B to begin running at a desired speed at block 64. When the colorant pumps are verified to be operating at the correct RPM by monitoring the speed signal from the AC drive (see block 66), this means that steady-state recirculation of the colorant from the colorant reservoirs 28A, 28B through the colorant pumps 30A, 30B to the dispensing valves 36A, 36B and back to the colorant reservoirs 36A, 36B is confirmed. At block 68, a time value “T” is set equal to zero and the required dispensing valves V1 . . . Vmax are opened (block 70). The time value T may be measured by an internal clock of the computer 52 or the PLC 50. Alternatively, a separate timing chip may be provided.

Continuing on FIG. 3B, at block 72, the time T is incremented by the desired amount. The smallest time interval of the system is limited only by the accuracy of the clock used, and may be on the order of microseconds. A count value “n” corresponding to the colorant number is set equal to 1 at block 74. At block 76, T is checked to determine if it equals the value “Tn” for the first colorant. If not, n is incremented to n+1 at block 78. At block 80, the value n is checked to determine if it is greater than the maximum value nmax. If not, the process returns to block 76 where the test is repeated to determine if time “Tn” for the subsequent colorant has been reached. If at block 76, the time tn has been reached, then the corresponding colorant valve “Vn” is closed (block 82) and the value of n is again incremented (block 78). The cycle through blocks 76 through 82 is subsequently repeated until all of the required colorants n1 through nmax are checked.

Once all the colorants have been checked at the initial time increment, the test at block 80 will indicate that n is greater than nmax. If this the case, then the system checks at block 84 to determine if all of the colorant valves have been closed. If this is not the case, then the system proceeds to block 72 where the time T is incremented. The process then proceeds to block 74 where n is reset equal to 1 and the loop of blocks 76 through 82 is repeated. If at block 84 all colorant valves have been closed, then the process proceeds to block 86 where the colorant pumps are stopped. The process is thus finished, as indicated at block 88.

The above-noted steps are merely a representative example of how a colorant flow may be measured using time-based metering, and they may be varied as need to suit an individual application. In particular, the step of recirculating the colorants may be eliminated under certain circumstances. For example, if a liquid dye were to be used, then the recirculation step would be eliminated because there would be no need to keep a pigment in suspension. In that case, The calibration chart would be modified to reflect the unsteady nature of the initial colorant flow after the colorant valves 36A, 36B are opened.

The foregoing has described a fluid tinting apparatus and method. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

What is claimed is:

1. A method of tinting a fluid, comprising:
(a) providing means for dispensing a colorant into a container;
(b) determining a preselected quantity of said colorant to be dispensed into said container to achieve a desired final color;
(c); determining a time required to dispense said preselected quantity of said colorant based on a flow characteristic of said dispensing means; and
(d) operating said dispensing means for said time so as to dispense said preselected quantity of colorant into said container.

2. The method of claim 1 wherein steps (a) through (d) are repeated for a plurality of colorants which collectively produce said desired final color.

3. The method of claim 1 wherein said flow characteristic is a steady-state flow rate.

4. The method of claim 1 wherein said flow characteristic is an effective flow rate which takes into account an initial period of unsteady flow.

5. The method of claim 1 wherein said step of determining a time required to dispense said preselected quantity of said colorant is carried out by referencing stored data representative of the quantity of colorant dispensed per unit time based on a known flow rate.

6. The method of claim 1 further comprising:
recirculating said colorant in a flow loop at a steady state flow rate when said colorant is not being dispensed.

7. The method of claim 2 further comprising:
providing a control system operably connected to said dispensing means, said control system programmed to operate said dispensing means for said time.

8. The method of claim 7 wherein said control system is programmed to:
receive a user input representing a quantity of a base fluid to be mixed;
receive a user input representing a final color desired; and
reference stored data which describes the correct quantity of each of a plurality of colorants required to produce the desired final color for a given quantity of said base fluid in order to determine the preselected quantity of each of said colorants to be dispensed into said container.

9. The method of claim 1 wherein said container holds a base fluid therein prior to said step of dispensing said colorant.

10. A tinting apparatus, comprising:
at least one colorant sub-system for dispensing a colorant into a container, comprising:
means for creating a flow of said colorant; and
a colorant valve which receives said colorant, said valve moveable between a first position which prevents flow of said colorant to a container, and a second position which allows flow of said colorant to said container; and
a control system operable to move said colorant valve to said second position for a preselected period of time based on a preselected quantity of colorant to be dispensed.

11. The tinting apparatus of claim 10 further comprising additional colorant sub-systems for dispensing additional colorants into said container, wherein each of said colorant sub-systems is operably connected to said controller.

12. The tinting apparatus of claim 10 wherein said colorant sub-system includes:
a reservoir for holding a supply of said colorant;
a pump for creating a flow of said colorant from said reservoir to said colorant valve; and
means for recirculating said flow of colorant from said colorant valve to said reservoir when said colorant valve is in said first position.

13. The tinting apparatus of claim 10 wherein said control system comprises:
a programmable logic controller operably connected to said colorant valve; and
a programmable computer operably connected to said programmable logic controller.

14. The tinting apparatus of claim 10 wherein said control system includes a stored calibration which correlates the quantity of colorant dispensed to a unit time at a specific flowrate.

15. The tinting apparatus of claim 11 wherein said control system includes stored data which describes the correct quantity of each colorant required to produce the desired color for a given volume of base fluid.
